(19) United States
(12) Patent Application Publication
(10) Pub. No.: US 2013/0089330 A1
(43) Pub. Date: Apr. 11, 2013

(54) Method And Apparatus For Efficient Operation Of A Passive Optical Communications Access Network

(71) Applicants: Hungkei Keith Chow, Livingston, NJ (US); Peter J. Vetter, Summit, NJ (US); Ka-Lun Lee, Southbank (AU); Behnam Sedighi, Coburg (AU); Rodney Tucker, Hawthorn (AU)

(72) Inventors: Hungkei Keith Chow, Livingston, NJ (US); Peter J. Vetter, Summit, NJ (US); Ka-Lun Lee, Southbank (AU); Behnam Sedighi, Coburg (AU); Rodney Tucker, Hawthorn (AU)

(73) Assignee: Alcatel-Lucent USA Inc., Murray Hill, NJ (US)

(21) Appl. No.: 13/530,665

(22) Filed: Jun. 22, 2012

Related U.S. Application Data
(60) Provisional application No. 61/543,824, filed on Oct. 6, 2011.

(51) Int. Cl. H04B 10/20

(52) U.S. Cl. 398/66

(57) ABSTRACT

A method and apparatus for providing an efficient optical access network. In a preferred embodiment, a single light source is used to generate light in a network node, such as an OLT (optical line terminal). The generated light is then distributed using an optical splitter to a plurality of outputs, each associated with an ONU. The distributed light intended for a particular ONU (optical network unit) is modulated, for example by an EOM (electro-optical modulator), with a signal carrying communications for the intended ONU. The OLT includes a bank of EOMs or other kind of optical modulators, such as EAMs for serving a plurality of ONUs. The OLT may also include a second light source for generating light that is propagated to one or more of the ONUs for their use in forming upstream transmissions.

### CROSS-REFERENCE TO RELATED APPLICATIONS

The present disclosure is related to and claims priority from U.S. Provisional Patent Application Ser. No. 61/543,824, entitled Energy Efficient Optical Transceiver Design for Optical Access Network, and filed on 6 Oct. 2011, the entire contents of which are incorporated by reference herein.

### TECHNICAL FIELD

The present invention relates generally to the field of optical communications access networks, and, more particularly, to a method and apparatus for transmitting and receiving optical signals in a manner that in many implementations is expected to significantly reduce the power consumption for the access network

### BACKGROUND

The following abbreviations are herewith defined, at least some of which are referred to within the following description of the state-of-the-art and the present invention.

CW Continuous Wave [laser]

### CWDM Course WDM

### DFB-LD Distributed Feedback Laser Diode

### DWDM Dense WDM

### EAM Electro-Absorption Modulator

### EOM Electro-Optical Modulator

### EAM Electro-Absorption Modulator

FIFO First In First Out [buffer]

### FTTH Fiber to the Home

### GPON Gigabit PONNNI

### NNI Network Node Interface

### OLT Optical Line Terminal

### OM Optical Modulator

### ONT Optical Network Terminal

### ONU Optical Network Unit

### PON Passive Optical Network

### PtMP Point to Multi-Point

### PtP Point to Point

### SDM Space-Division Multiplexing

### TEC Thermal Electric Cooler

### TDD Time Division Duplexing

### WDD Wavelength Division Duplexing

### VCSEL Vertical Cavity Surface-Emitting Laser

### WDM Wavelength Division Multiplexing

### UNI User Network Interface

### VLAN Virtual Local Area Network

The access portion of a communications network, which may itself also be referred to as an access network, extends from the core or core portion of the network to individual subscribers, such as those associated with a residence or small business location. Access networks may be wireless access, such as a cellular telephone network, or fixed access, such as a PON or cable network. The access network typically though not necessarily ends at a demarcation point on or near the outside of a subscriber premises.

An optical access network, generally speaking, employs a transceiver that interfaces with the core network to handle downstream and upstream traffic, which may facilitate a number of communication-network services such as content delivery, Internet access, and voice communications. The transceiver communicates with individual subscribers over fiber optic cables. These fiber optic cables may not extend all of the way from the transceiver to subscriber premises, though all-fiber optical access networks are becoming increasingly common.

Many optical access networks use a point-to-multipoint configuration, meaning that communications for a number of subscribers traverse the same fiber. In a typical PON access network, for example, a single fiber extends from the transceiver to an optical splitter located in a street cabinet or similar structure, which is often referred to as the “outside plant” and is generally located relatively near to the subscribers that it serves. The optical splitter distributes the downstream signal to individual fibers running from the outside plant to an ONU located at each subscriber's premises, and collects the upstream transmission for transmission along the single fiber to the optical line termination (OLT), typically located in the Central Office (CO).

A number of techniques have evolved for permitting such transmissions. In a typical PON, each of these fibers carries the same downstream optical transmission to the ONUs, which can individually determine which portion of the downstream transmission is for them. TDM is used, for example, in EPON and 10GEPON networks as specified in IEEE 802.3ah/av, and in GPON and XGPON networks as specified in ITU G.984/G.987. In TDM, time slots are assigned for certain downstream and upstream transmissions in the optical network. Multiple communications do not interfere with each other because they occur at different times. WDM and OFDM solutions have also been proposed, using a number of wavelengths or subcarriers to avoid interference.

Unfortunately, each of the solutions imposes either additional complexity or energy burden on the access network, or both. TDM requires a high aggregate bit rate to accommodate all of the separate communications. WDM usually requires sophisticated and energy-hungry temperature control to achieve each of the desired wavelengths, and OFDM utilizes complex signal processing. Needed then is an efficient transmission scheme for optical networks transmissions that can attempt to mitigate or eliminate these disadvantages.

Note that the techniques or schemes described herein as existing or possible are presented as background for the present invention, but no admission is made thereby that these techniques and schemes were heretofore commercialized or known to others besides the inventors.

### SUMMARY

The present invention is directed to a manner of providing energy-efficient optical network access using a point to point architecture. In one aspect, the present invention is an apparatus for an optical access network including a light source, an optical splitter for receiving and distributing light from the light source to a plurality of outputs, and a plurality of optical modulators, each optical modulator for receiving light from a respective one of the optical splitter outputs and modulating the light for transmission of signals from the apparatus. An advantage of embodiments of the present invention is that modulation of an optical modulator per subscriber line at the data rate of an individual subscriber in combination with the shared output of a CW laser sources consumes significantly less energy than either separately modulated lasers for each subscriber line in a point-to-point access scheme or a shared laser modulated at a higher aggregate rate in a TDM PON scheme. Advantageously, the optical modulators may be, for example EOMs (electro-optical modulators), or EAMs (electro-absorption modulators). Unlike a current driven laser, an EOM is a voltage driven capacitance and hence consumes very little power. An EAM may be expected to consume even less power.

In a preferred embodiment, the light source, the optical splitter, and the optical modulators are located in an OLT (optical line terminal), and the light source is a CW-DFB-LD (continuous wave distributed feedback laser diode). Some embodiments of the invention also include optical modulator driver circuitry for directing optical modulator operation, which may take the form of a plurality of optical modulator drivers, each optical modulator driver associated with a respective one of the plurality of optical modulators s.

In some embodiments, this aspect of the present invention may also include a plurality of optical fibers, each optical fiber associated with an output of the optical splitter and a network interface for interfacing with a core network. A packet processing train may be present between the network interface and the optical modulator driver circuitry for processing transmissions received from the core network. If so, the packet processing train may include a packet processor, a traffic manager, at least one buffer, and at least one serializer.

In some embodiments, this aspect of the present invention may also include a second light source for generating light, for example in an OLT, and distributing it downstream to at least one ONU (optical network unit) for upstream transmissions, and a second optical splitter for distributing light generated by the second light source to a plurality of outputs. The light generated by the second light source is preferably of a different wavelength that the light generated by the light source for downstream transmission. It is thereby a wavelength division duplexing scheme. In these embodiments, the apparatus may also include at least one optical circulator for receiving light from the second optical splitter and propagating it along a fiber to the at least one ONU. In most implementations, there will be a number of optical circulators, each associated with an ONU, receiving light generated by the second light source and distributed by the second optical splitter. In other embodiments, for example where a second light source is not present in an OLT, upstream and downstream transmission may occur in different time slots and thereby in a time division duplexing scheme.

In another aspect, the present invention is an optical access network comprising an OLT, the OLT comprising a plurality of optical modulators s, each optical modulator for modulating light received from a light source to generate signals for transmission to an ONU. The OLT may also include a light source and an optical splitter positioned between the light source and the plurality of optical modulators. In some embodiments, the optical access network of the present invention may also include a plurality of optical fibers for transmitting light from the optical splitter to the plurality of optical modulators. If so, the plurality of fibers may form a cable bundle such as a multi-core or ribbon optical fiber for transmitting light from the plurality of optical modulators to at least one ONU.

In some embodiments, the optical access network may also include at least one ONU. The ONU may comprise a light source or a light circulator for upstream transmissions, or both. In embodiments having a light circulator in the ONU for upstream transmissions, the OLT may include a plurality of light circulators respectively associated downstream ONUs, the light circulator for receiving light from a second light source and distributed by an optical splitter.

In yet another aspect, the present invention is a method of transmitting downstream signals to an ONU from an OLT in an optical access network, including generating light by a light source, distributing the generated light to a plurality of optical modulators, and modulating the distributed light by at least one of the plurality of optical modulators. The method may include receiving in an ONU the light modulated by the at least one optical modulator. Embodiments of the invention may also include receiving at the OLT a transmission from a core network. If so, the method may further include determining one or more ONUs for which the transmission is intended. The light source may in some case be activated only when there is data to transmit and deactivated at other times.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating selected components of a typical PON according to the existing art;

FIG. 2 is a simplified schematic diagram illustrating selected components of a PtP access network according to an embodiment of the present invention;

FIG. 3 is a simplified schematic diagram illustrating selected components of an OLT transmitter according to an embodiment of the present invention;

FIG. 4 is a simplified schematic diagram illustrating selected components of an ONU receiver according to an embodiment of the present invention;

FIG. 5 is a simplified schematic diagram illustrating an OLT receiver according to another embodiment of the present invention;

FIG. 6 is a simplified schematic diagram illustrating selected components of an ONU transmitter according to another embodiment of the present invention;

FIG. 7 is a simplified schematic diagram illustrating selected components of an OLT receiver according to another embodiment of the present invention;

FIG. 8 is a simplified schematic diagram illustrating selected components of an ONU transmitter according to another embodiment of the present invention; and

FIG. 9 is a flow diagram illustrating a method according to an embodiment of the present invention.

### DETAILED DESCRIPTION

The present invention is directed toward a way of transmitting in an optical network such as a PON (passive optical network). The apparatus and method are configured in a manner as to promote network efficiency as will be described in more detail below.

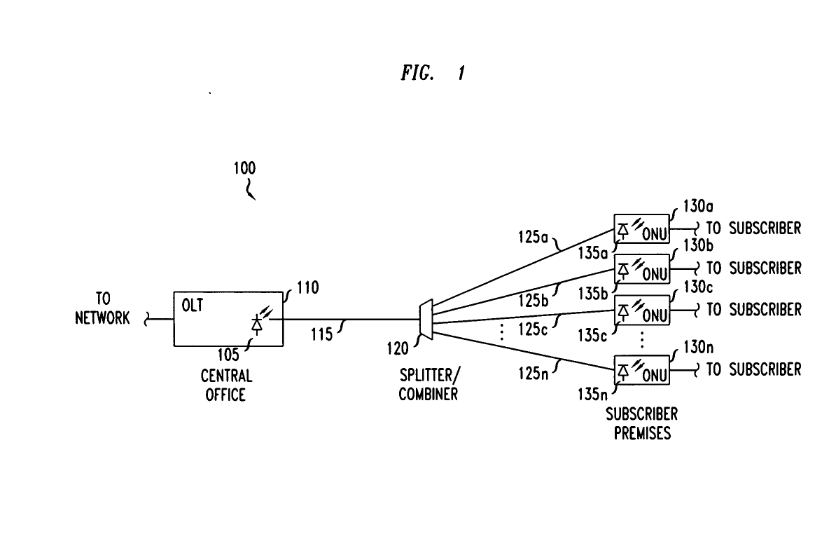

A PON may be used as an access network, the portion of a larger network that permits access for individual subscribers or groups of subscribers. FIG. 1 is a simplified schematic diagram illustrating selected components of a typical PON 100 according to the existing art. Exemplary PON 100 includes an OLT (optical line terminal) 110, which among other functions serves as a connection between a core network or networks (not shown). “Core network” is here being used in the general sense as a communication network through which subscribers may obtain downloaded content, communicate with others, access the Internet, and similar functions. The core network may itself include, for example, application servers and data storage devices for facilitating these functions or may interconnect with other networks, or both.

Downstream traffic from the core network is directed to one or more subscribers via the PON 100, and upstream traffic flows in the other direction, from subscribers toward the core network. Generally speaking, in this exemplary PON 100, the OLT 110 includes the apparatus (not shown in FIG. 1) necessary for exchanging network and subscriber communications. In many installations it is physically located in a building or similar structure referred to as the CO (central office).

For effecting downstream transmissions, the OLT includes a light source 105, which may for example be a laser or LED device. While only a single light source is depicted in FIG. 1, there are often a number of light sources in a single OLT. Light generated by the light source 105 propagates along feeder fiber 115 until it is received in optical splitter/combiner 120 (sometimes referred to for convenience as simply an optical splitter).

In exemplary PON 100, optical splitter 120 distributes the light propagated downstream along feeder fiber 115 to a number of outputs. In FIG. 1, four such outputs are shown, each communicating with a respective access fiber. The access fibers are in FIG. 1 referred to as 125a through 125n. As indicated by the ellipsis, there may be additional access fibers communicating with their own respective optical splitter outputs (there may of course, be less than four as well). Although not shown in FIG. 1, each output may form a port into which an access fiber connector is received.

Optical splitter 120 is typically a passive device requiring no power but simply distributing light propagating in the downstream direction onto each one of its ports. In many PONs, therefore, the signals transmitted in the propagated light are identically passed to each of the access fibers. In the PON 100 of FIG. 1, these signals are received at ONUs (optical network units) 130a through 130n, each of which communicate with a respective one of access fibers 125a through 125n.

As mentioned above, an ONU may be associated with a single subscriber, as is typically, for example, an ONT (optical network terminal; not shown), and is often located on or near the subscriber's premises. In the example of FIG. 1, this is assumed to be the case for ONUs 130a through 130n. Each of the ONUs 130a through 130n includes a light detector 135a through 135n, respectively, and acts as the interface between the PON 100 and one or more subscriber devices such as a home router or gateway (not shown).

Note that in this exemplary PON 100, each of the ONUs receives the same downstream transmission but selects only that portion of the transmission stream addressed to it. Data not addressed to a particular ONU is simply discarded. This means, of course, that the OLT 110 must aggregate all of the traffic for ONUs 130a through 130n and properly schedule its transmission so that each ONU is served in a satisfactory fashion. Of course, each ONU must also deal with all of this aggregated traffic even though it does not fully process the traffic addressed to other ONUs. Exemplary PON 100 is therefore somewhat inefficient.

Upstream traffic in exemplary PON propagates along the same path, originating in the ONUs 130a through 130n and transmitted in accordance with a time schedule established by OLT 110. The upstream traffic may use light of a different wavelength to avoid interference with downstream traffic, but the schedule is necessary so that ONU transmission don't interfere with each other. A transmission from one of the ONUs 130a through 130n propagates along a respective one of the access fibers 125a through 125n to optical splitter combiner 120, where it is placed on feeder fiber 115 and eventually reaches a light detector (not shown) in OLT 110.

The exemplary PON 100 of FIG. 1 may be considered a PtMP (point to multi-point) system. The inventors have found, however, that many of the energy inefficiencies inherent in such a system may be addressed by a PtP (point to point) optical network configured according to the present invention. Exemplary embodiments of such a PtP optical network will now be described in more detail. Note that while EOMs (electro-optical modulators) are variously employed in these embodiments, other embodiments not explicitly described may also or instead use other kinds of optical modulators, such as electro-absorption modulators (EAMs).

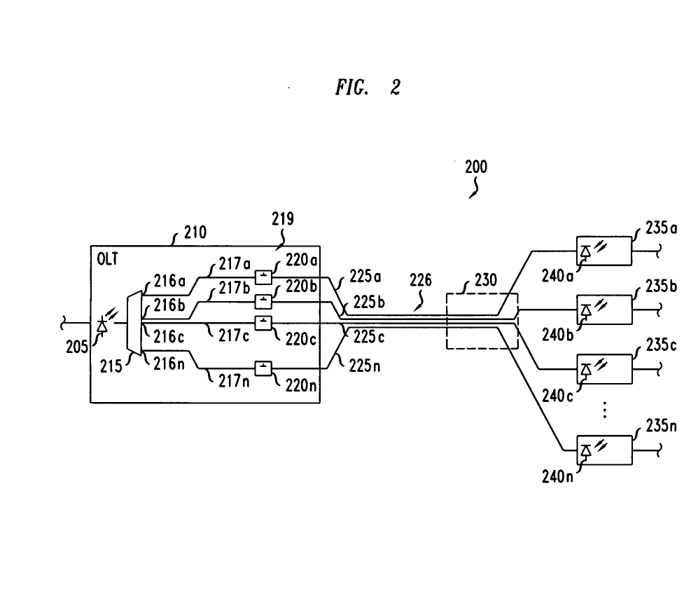

Turning first to FIG. 2, FIG. 2 is a simplified schematic diagram illustrating selected components of a PtP access network 200 according to an embodiment of the present invention. As should be apparent, the basic structure of PtP network 200 has some similarities to the PON 100 described above. An OLT 210 serves as an interface between a core network and the PtP network 200, and uses optical fibers to communicate with a plurality of ONUs.

In accordance with this embodiment of the present invention, however, OLT 210 includes a light source 205 associated with PtP network 200. Note that while this single light source 205 is sufficient for all downstream transmissions in PtP 200, the lack of one or more additional light sources is not a requirement of the invention. Use of only a single associated light source in OLT 210, however is considered the most efficient solution. Note also that additional light sources associated with other PtP networks (not shown) that originate from OLT 210 may also in some implementations be included.

In a preferred embodiment, the light source is a laser, and in particular a CW (continuous wave) DFB-LD (distributed feedback laser diode). It is an advantage though not a requirement of the present invention that the laser or other light source does not have to be tunable or capable of emitting at multiple wavelengths.

In the embodiment of FIG. 2, also present in the OLT 210 is an optical splitter 215, which receives the light generated by the light source 205 and distributes it to a plurality of outputs 216a through 216n. Again, although four outputs are shown in FIG. 2, there may be any number. Light distributed from the outputs 216a through 216n propagates respectively along optical conduits 217a through 217n. Note here that “conduit” is intended as a general term for the medium through which light distributed by optical splitter 215 reaches the EOM bank 219. Note also that its apparent length is for purposes of illustration only. EOM bank 219 includes one or more EOMs that receive the light generated by the light source 205 and distributed by optical splitter 215.

In this embodiment, EOM bank 219 includes EOMs 220a through 220n. Again, although four are shown in FIG. 2, there may be any number, and no particular physical configuration is required. Each operational EOM modulates the light beam passing through it in some fashion to impose a signal on the propagating light that may be interpreted by the a downstream device such as one of the ONUs 235a through 235n. In other words, according to this embodiment of the present invention un-modulated light from the light source is distributed by an optical splitter to one or more EOMs where it is modulated for transmission to an ONU.

In the embodiment of FIG. 2, a respective one of PtP fibers 225a through 225n carries the downstream signal from an EOM to and ONU. For example, light modulated by EOM 220a is transmitted to ONU 235a along PtP fiber 225a. Although a continuous fiber run from EOM 220a to ONU 235a is contemplated in FIG. 2, there may in implementation be slices or intermediate components present in some cases. As shown in FIG. 2, the individual fibers 225a through 225n may form a fiber bundle 226, such as a multi-core or ribbon fiber along at least part of their length. Outside plant 230, represented by a dashed box, may be the location that the individual fibers of bundle 226 are physically separated for runs to each individual ONU. A bundled fiber configuration is not required, of course.

In this embodiment, each of the ONUs 235a through 235n includes a respective light detector 240a through 240n. Light carrying downstream transmissions from OLT 210 is detected and the signals carried further processed. Each ONU 235a through 235n may then pass the downstream communications to the subscriber equipment (not shown).

Again it is noted that an advantage is gained by providing each of the ONUs with only traffic addressed or intended for their respective subscriber, or for operations, maintenance, and administrative communications intended for the particular ONU. Of course, the present invention does not preclude transmitting non-relevant information to a particular ONU but an over-abundance of such information would erode the advantages of the PtP communications of the present invention. Finally, it is noted that the signal-bearing light created by a single EOM of the EOM bank may be split and used by more than one ONU; however this is not a preferred embodiment.

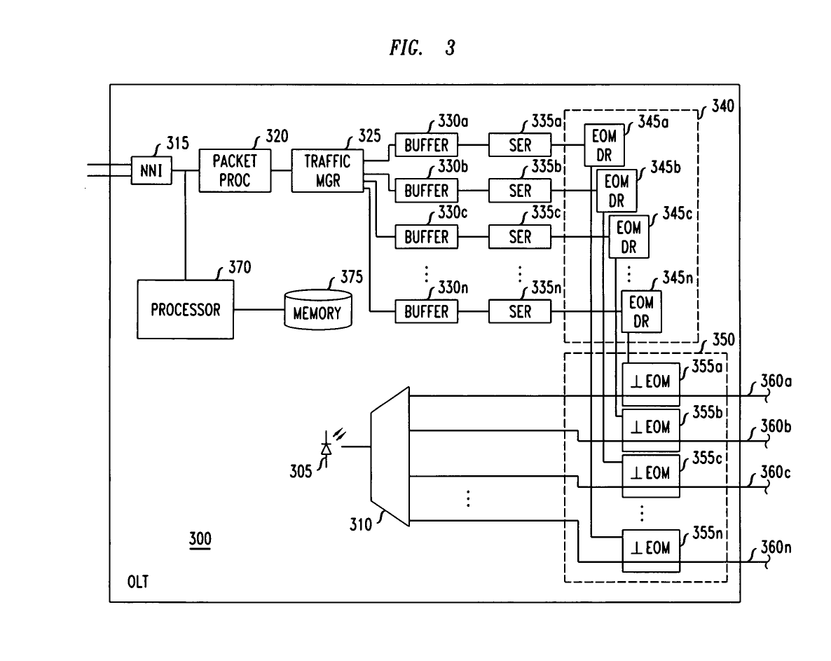

FIG. 3 is a simplified schematic diagram illustrating selected components of an OLT 300 according to an embodiment of the present invention. In this embodiment, OLT 300 includes a light source 305 and an optical splitter 310. As with OLT 210 of FIG. 2, the light source is preferably a single CW-DFB-LD, although other light sources may be used as well. Optical splitter 310 is shown with four outputs referred to as 311a through 311n, though there may be any number. Each of the outputs 311a through 311n is associated with a respective optical conduit 312a through 312n.

In the embodiment of FIG. 3 each of the optical conduits 312a through 312n is associated with a respective one of EOMs 355a through 355n of EOM bank 350. Light generated by light source 305 and distributed by optical splitter 310 may be modulated by the EOMs 355a through 355n and the modulated light signals continue downstream on a respective one of the optical fibers 360a through 360n.

Also shown in FIG. 3 are selected components of the downstream data transmission train. In this embodiment, EOM driver circuitry 340 includes an EOM driver 345a through 345n, each associated with a respective one of the EOMs 355a through 355n.

In this embodiment, data to be transmitted to the ONUs may be received at NNI 315 and is processed by packet processor 320. Note that the term “data” is being used in a general sense, and received data may represent any downstream audio or video content, voice calls, and so forth. The components described herein, of course, may also be used to process, transmit, and receive communications from one device in the PtP network to another. After processing, the packets are passed to traffic manager 325, which in turn places downstream data to be transmitted into one or more of the buffers 330a through 330n. From buffers 330a though 330n, the downstream traffic is serialized by serializers 335a through 335n and passed to the EOM drivers 345a though 345n so that the light passing through EOMs 355a through 355n may be modulated accordingly.

In the embodiment of FIG. 3, OLT 300 also includes a processor 370 for controlling operation of the various other components of OLT 300, for example in accordance with program instructions stored on non-transitory memory device 375. The illustrated connection between processor 370 and the downstream transmission train is representative of the interconnection of these components but other configurations are possible. The components illustrated in FIG. 3 are implemented in hardware or software executing on a hardware device, or a combination of both.

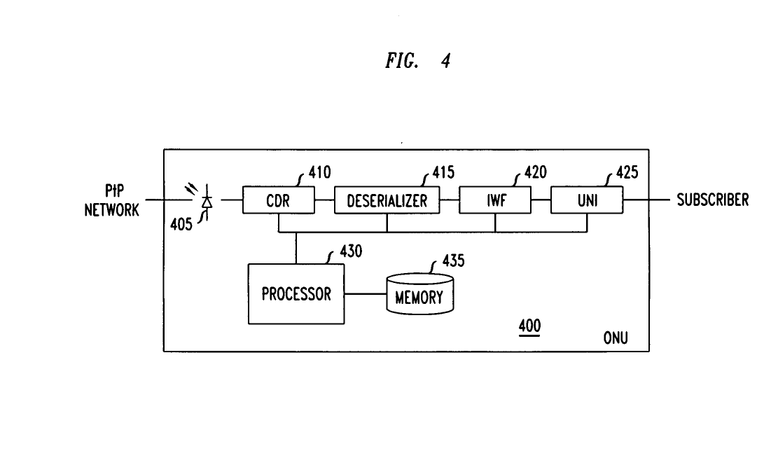

As mentioned above, most of the components illustrated In FIGS. 2 and 3 are involved in downstream transmission, that is, in the transmission of data traffic from the OLT to an ONU. FIG. 4 is a simplified schematic diagram illustrating selected components of an ONU 400 according to an embodiment of the present invention. In this embodiment, ONU 400 includes a light detector and analog front-end circuitry 405 for receiving downstream transmissions, which are then passed through CDR module 410 and deserializer 415. An IWF (interworking function) 420 receives and processing the deserialized traffic before passing it to the UNI (user network interface) 425 for transmission to one or more subscriber devices. In an alternate embodiment (not shown) that employs an optical UNI, deserializer 415 may be omitted. In that embodiment, IWF adapts the serial data received from CDR before passing to the optical UNI.

In the embodiment of FIG. 4, ONU 400 also includes a processor 430 for controlling operation of the various other components of ONU 400, for example in accordance with program instructions stored on non-transitory memory device 435. The illustrated connection between processor 430 and the downstream transmission train is representative of the interconnection of these components but other configurations are possible. The components illustrated in FIG. 4 are implemented in hardware or software executing on a hardware device, or a combination of both.

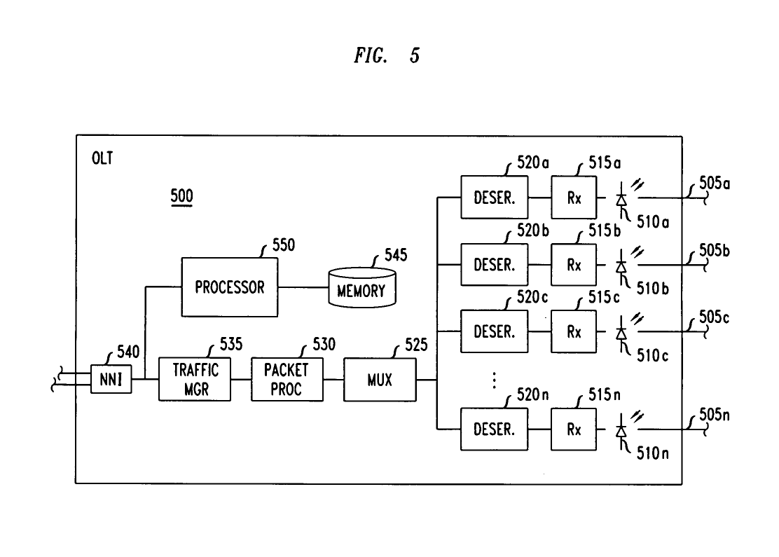

Of course, a PtP network embodying the present invention will handle upstream traffic as well. A number of different implementation configurations are possible, some of which will now be described. FIG. 5 is a simplified schematic diagram illustrating selected components of an OLT 500 according to an embodiment of the present invention. OLT 500 receives upstream transmissions via optical fibers 505a through 505n from ONUs (not shown in FIG. 5) associated with subscribers. In most implementations, the same fibers will be used for both upstream and downstream transmission. To avoid interference different wavelengths can be used, or selected time slots allocated for upstream communications, or both.

In the embodiment of FIG. 5, the received light is detected and converted into an electrical signal by a respective one of the light detectors and analog front-end circuitry 510a through 510n and is processed by receive circuitry 515a through 515n. In this preferred embodiment, there is a light detector for each incoming fiber 505a through 505n. The upstream traffic is then deserialized by deserializers 520a through 520n and passed to multiplexer 525. The multiplexed traffic stream then passes through packet processor 530 and traffic manager 535 prior to being handed to NNI 540 for transmission to the core network.

In the embodiment of FIG. 5, OLT 500 also includes a processor 550 for controlling operation of the various other components of OLT 500, for example in accordance with program instructions stored on non-transitory memory device 545. The illustrated connection between processor 550 and the downstream transmission train is representative of the interconnection of these components but other configurations are possible. The components illustrated in FIG. 5 are implemented in hardware or software executing on a hardware device, or a combination or both.

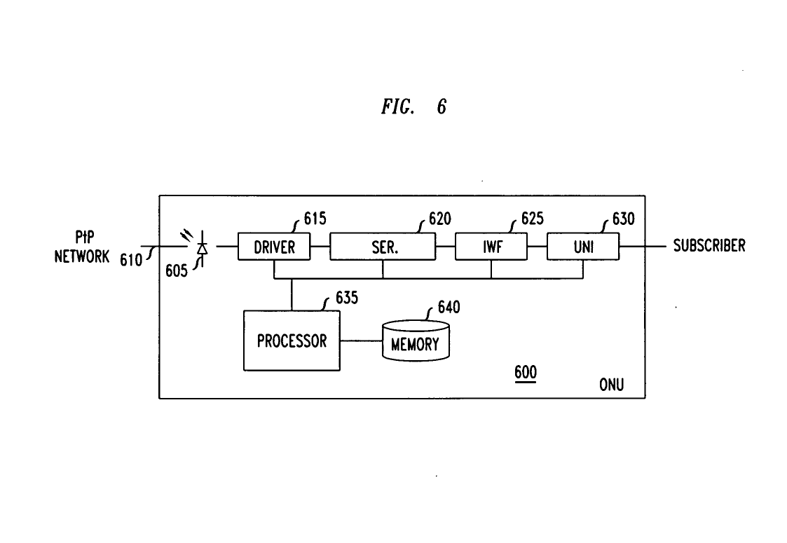

An ONU for upstream traffic is shown in FIG. 6. FIG. 6 is a simplified schematic diagram illustrating selected components of an ONU 600 according to an embodiment of the present invention. Upstream traffic from the subscriber received at UNI 630 passes through interworking function 625 and then is serialized by serializer 620. Driver 615 uses the serialized data traffic to drive the operation of light source 605. Light source 605 may be for example, a laser diode. The light then propagates along optical fiber 610 toward the OLT (not shown in FIG. 6). Here it is noted that fiber 610 may correspond with one of the optical fibers 505a through 505n illustrated in FIG. 5, though ONU 600 may be used with differently configured OLTs as well.

In an alternate embodiment (ot shown) an optical LINT is employed. In this case data receiving from the UNI may be in serial format, so the serializer may be omitted. The IWF then adapts the UNI output data rate to the PON line rate before passing it along.

Returning to the embodiment of FIG. 6, ONU 600 also includes a processor 635 for controlling operation of the various other components of ONU 600, for example in accordance with program instructions stored on non-transitory memory device 640. The illustrated connection between processor 635 and the downstream transmission train is representative of the interconnection of these components but other configurations are possible. The components illustrated in FIG. 6 are implemented in hardware or software executing on a hardware device, or a combination or both.

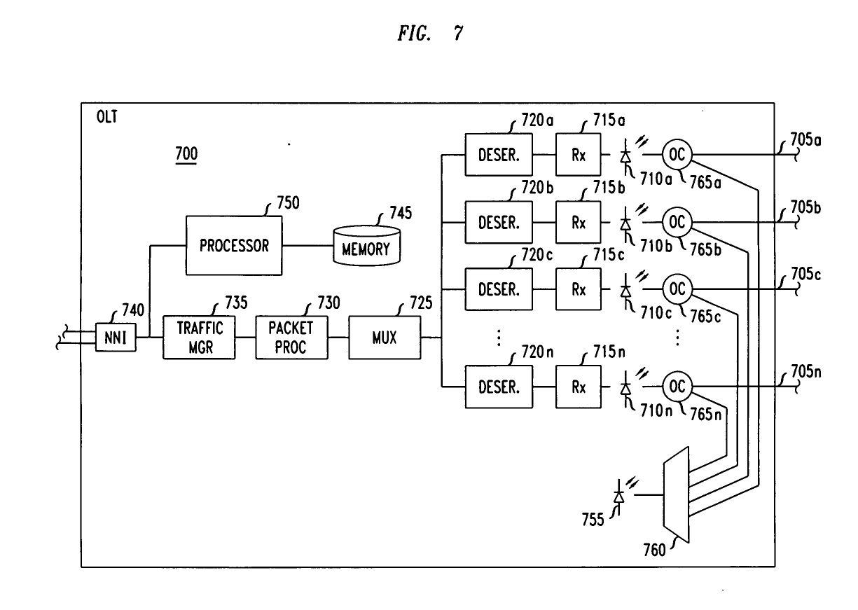

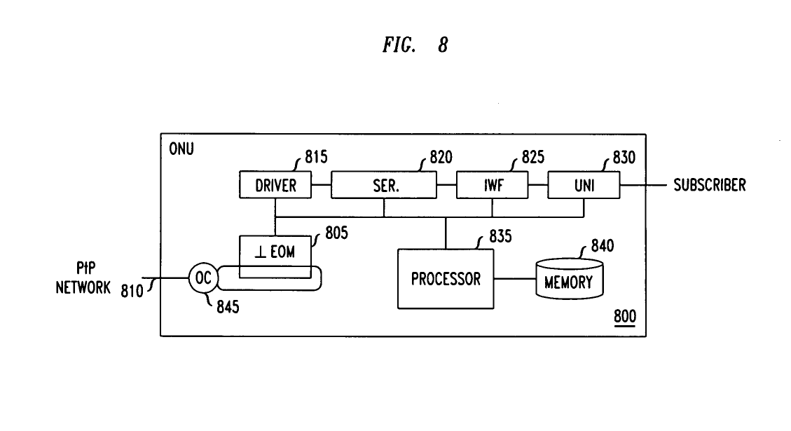

A somewhat different configuration for upstream transmission is shown in FIGS. 7 and 8. FIG. 7 is a simplified schematic diagram illustrating selected components of an OLT 700 according to an embodiment of the present invention. In this embodiment, OLT 700 includes an upstream traffic train including a multiplexer 725 for multiplexing upstream traffic, a packet processor 730 and a traffic manager 735. NNI 740 provides an interface to the core network (not shown). Deserializers 720a through 720n deserialize upstream traffic from receiver circuitry 715a through 715n as detected by light detectors 710a through 710n, which also include analog front end circuitry.

In this embodiment of the present invention, the input to each light detector 710a through 710n arrives from a respective one of the optical fibers 705a through 705n via an optical circulator 765a through 765n. Each optical circulator directs the light beam from an optical fiber to an associated optical detector. In addition, optical circulators 765a through 765n directs light from light a respective output of optical splitter 760 to propagate downstream on optical fibers 705a through 705n to the ONUs (not shown) served by the OLT 700. In this embodiment, light generated in the OLT 700 is made available to the ONUs, which may use it to transmit their upstream traffic (refer, for example to FIG. 8). Light source 755 is preferably a CW laser.

In the embodiment of FIG. 7, OLT 700 also includes a processor 750 for controlling operation of the various other components of OLT 700, for example in accordance with program instructions stored on non-transitory memory device 745. The illustrated connection between processor 750 and the downstream transmission train is representative of the interconnection of these components but other configurations are possible. The components illustrated in FIG. 7 are implemented in hardware or software executing on a hardware device, or a combination or both.

An ONU 800 that may be advantageously implemented along with the OLT 700 is described in reference to FIG. 8. In this context, however, note that other configurations are possible; for example ONU 600 of FIG. 6 may also be served by the OLT 700. FIG. 8 is a simplified schematic diagram illustrating selected components of an ONU 800 according to an embodiment of the present invention. In this embodiment, ONU 800 does not employ a light source of its own for upstream transmissions. Instead, light from an external light source such as light source 755 of OLT 700 (shown in FIG. 7) provides light to some or all of the ONUs it serves.

Of course, the light source external to OLT 800 may instead be located elsewhere, for example somewhere in else in the CO or even in an outside plant. And all of the ONUs in a particular PtP network are not required to use light from an external source for upstream transmissions.

In embodiment of FIG. 8, light from the external light source is received on fiber optic cable 810 and enters optical circulator 845. The optical circulator 845 receives the light from fiber 810 and provides it to EOM 805, where it is modulated according to directions received from EOM driver 815. The modulated light is propagated back toward the OLT along fiber 810 via optical circulator 845.

In this embodiment, UNI 830 interfaces with the subscriber device or devices and receives upstream traffic for transmission. The upstream drive train of ONU 800 also includes an interworking function 825 and an optional serializer 820, positioned between the UNI 830 and the EOM driver 815. In an alternate embodiment, an optical UNI is used, and in that case the serializer may be omitted; the serial data output from UNI is adapted by the IWF before passing to the EOM driver.

In the embodiment of FIG. 8, ONU 800 also includes a processor 835 for controlling operation of the various other components of ONU 800, for example in accordance with program instructions stored on non-transitory memory device 840. The illustrated connection between processor 835 and the downstream transmission train is representative of the interconnection of these components but other configurations are possible. The components illustrated in FIG. 8 are implemented in hardware or software executing on a hardware device, or a combination or both.

The embodiments of FIG. 3-4 and FIG. 7-8 may also be combined e.g. by means of CWDM on two separate wavelengths or in a Time Division Duplexing (TDD) scheme on the same wavelength to achieve bi-directional transmission.

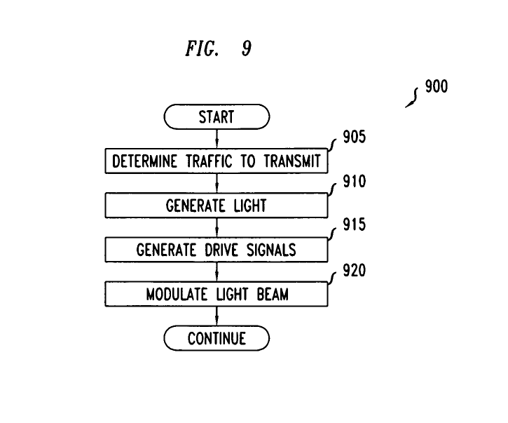

FIG. 9 is a flow diagram illustrating a method of signal transmission in a PON access network according to an embodiment of the present invention. At START it is presumed that the components performing the method are in place and operational according to this embodiment. The process then begins with determining that there is downstream traffic to transmit (step 905). In typical operation, this may simply include receiving traffic from a core communication network that is addressed or otherwise designated for delivery to at least one ONU. Of course, there may also be internally-generated traffic such maintenance or testing communications. The determination of step 905 may also include determining that a target ONU is actually available or operational to receive the communication, although will not be done in all cases.

In the embodiment of FIG. 9, once it is determined that there is downstream traffic to transmit, the process continues with generating light by a light source (step 910). It is here noted that this implies that the light source is not continuously operated, but in some other implementations it will be. As mentioned above, in most implementations the light source is a laser, and in a preferred embodiment the light source is a single CW-DFB laser located in the OLT of the PON access network. The light generated by the light source is used for multiple point-to-point communications though of course there is no requirement that communications to multiple ONUs are actually taking place.

In this embodiment, the light generated by the light source is then distributed (step 910) by an optical splitter, also preferably positioned within the OLT, to one or more outputs. At least one EOM driver processes the downstream communications to generate drive signals (step 915) for a bank of one or more EOMs, each EOM associated with a respective optical splitter output. In response to these drive signals, each appropriate EOM then modulates the light (step 920) to produce a signal for transmission. Note, however, that there is no requirement that more that one optical splitter output or EOM be operational unless recited in a particular embodiment. The signals are then received (step 920) in an ONU of the PON. The process continues with the transmission further signals as needed for downstream communications.

Note that the sequence of operation illustrated in FIG. 9 represents an exemplary embodiment; some variation is possible within the spirit of the invention. For example, additional operations may be added to those shown in FIG. 9, and in some implementations one or more of the illustrated operations may be omitted. In addition, the operations of the method may be performed in any logically-consistent order unless a definite sequence is recited in a particular embodiment.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. Apparatus for an optical access network, comprising:
a light source;
an optical splitter for receiving and distributing light from the light source to a plurality of outputs;
a plurality of optical modulators, each EOM for receiving light from a respective one of the optical splitter outputs and modulating the light for transmission of signals from the apparatus.

2. The apparatus of claim 1, wherein the light source, the optical splitter, and the optical modulators are located in an OLT (optical line terminal).

3. The apparatus of claim 1, wherein the light source is a CW-DFB-LD (continuous wave distributed feedback laser diode).

4. The apparatus of claim 5, further comprising optical modulator driver circuitry for directing EOM operation, wherein the optical modulator driver circuitry comprises a plurality of optical modulator drivers, each optical modulator driver associated with a respective one of the plurality of EOMs.

5. The apparatus of claim 1, wherein the optical modulator is an EOM (electro-optical modulator).

6. The apparatus of claim 1, wherein the optical modulator is an EAM (electro-absorption modulator).

7. The apparatus of claim 1, further comprising a plurality of optical fibers, each optical fiber associated with an output of the optical splitter.

8. The apparatus of claim 1, further comprising a network interface for interfacing with the core network and a packet processing train between the network interface and the optical modulator driver circuitry for processing transmissions received from the core network.

9. The apparatus of claim 8, wherein the packet processing train comprises a packet processor, a traffic manager, at least one buffer, and at least one serializer.

10. The apparatus of claim 1, further comprising a second light source for generating light and distributing it to at least one ONU (optical network unit) for upstream transmissions.

11. The apparatus of claim 10, wherein the light generated by the second light source is different than the light generated by the light source.

12. The apparatus of claim 10, further comprising a second optical splitter for distributing light generated by the second light source to a plurality of outputs.

13. The apparatus of claim 12, further comprising at least one optical circulator for receiving light from the optical splitter and the second optical splitter and propagating it along a fiber to the at least one ONU.

14. An optical access network comprising an OLT, the OLT comprising a plurality of optical modulators, each optical modulator for modulating light received from a light source to generate signals for transmission to an ONU.

15. The optical access network of claim 14, wherein the OLT further comprises a light source.

16. The optical access network of claim 15 wherein the OLT further comprises an optical splitter positioned between the light source and the plurality of optical modulators.

17. The optical access network of claim 16, further comprising a plurality of optical fibers for transmitting light from the optical splitter to the plurality of optical modulators.

18. The optical access network of claim 14, further comprising a cable bundle for transmitting light from the plurality of optical modulators to at least one ONU.

19. The optical access network of claim 18, wherein the cable bundle comprises a multicore optical fiber.

20. The optical access network of claim 14, further comprising at least one ONU.

21. A method of transmitting downstream signals to an ONU from an OLT in an optical access network access network, comprising:
generating light by a light source;
distributing the generated light to a plurality of optical modulators; and
modulating the distributed light by at least one of the plurality of optical modulators.

22. The method of claim 21, wherein modulating the distributed light by at least one of the plurality of optical modulators comprises modulating the distributed light by one or more EOMS that are associated with the one or more ONUs.

23. The method of claim 21, further comprising determining whether there is downstream traffic to transmit prior to generating light by the light source.
